(19) United States
(12) Patent Application Publication
(10) Pub. No.: US 2025/0303904 A1
(43) Pub. Date: Oct. 2, 2025

(54) CALENDAR-BASED CHARGING STRATEGIES FOR ELECTRIFIED VEHICLES

(71) Applicant: Ford Global Technologies, LLC, Dearborn, MI (US)

(72) Inventors: Lars Niklas Pettersson, Novi, MI (US); Anne Pinlac, Dearborn Heights, MI (US); Prahlad Rajiv Saggere, Wixom, MI (US); Christopher C. Ahrns, Commerce Twp, MI (US); Richard B. Eckenrode, Royal Oak, MI (US); William D. Treharne, Ypsilanti, MI (US)

(21) Appl. No.: 18/618,142

(22) Filed: Mar. 27, 2024

(51) Int. Cl. B60L 53/62; B60L 53/66; B60L 53/68; B60L 58/12

(52) U.S. Cl. CPC B60L 53/62; B60L 53/66; B60L 53/68; B60L 58/12; B60L 2250/14; B60L 2260/52; B60L 2260/54; B60L 2260/58

(57) ABSTRACT

A battery pack of an electrified vehicle is charged according to a calendar-based charging strategy. When following the calendar-based charging strategy, the battery pack is charged to a state of charge sufficient for the electrified vehicle to travel from a starting location of the electrified vehicle to a destination by an expected departure time. The destination and the expected departure time are based on calendar information of a user of the electrified vehicle. Further, when following the calendar-based charging strategy, other charging strategies are overridden.

### TECHNICAL FIELD

This disclosure relates generally to calendar-based charging strategies for electrified vehicles.

### BACKGROUND

A high voltage traction battery pack typically powers electric machines and other electrical loads of an electrified vehicle. The battery pack includes a plurality of battery cells that must be periodically recharged to replenish the energy necessary to power these loads. The battery pack is typically charged by connecting the vehicle to an external power source that transfers electric energy to the battery pack.

### SUMMARY

In some aspects, the techniques described herein relate to a method, including: charging of a battery pack of an electrified vehicle according to a calendar-based charging strategy, wherein, when following the calendar-based charging strategy, the battery pack is charged to a state of charge sufficient for the electrified vehicle to travel from a starting location of the electrified vehicle to a destination by an expected departure time, wherein the destination and the expected departure time are based on calendar information of a user of the electrified vehicle, wherein, when following the calendar-based charging strategy, other charging strategies are overridden.

In some aspects, the techniques described herein relate to a method, wherein a control system is programmed to control charging of the battery pack.

In some aspects, the techniques described herein relate to a method, wherein the control system is a component of the electrified vehicle and is powered by the battery pack, or the control system is a component of a server system.

In some aspects, the techniques described herein relate to a method, further including: calculating an amount of charge time required for the battery pack to reach the state of charge sufficient for the electrified vehicle to travel to the destination, and beginning to charge the battery pack according to the calendar-based charging strategy at a charge initiation time determined by subtracting the calculated amount of charge time from the expected departure time.

In some aspects, the techniques described herein relate to a method, wherein the expected departure time is determined by subtracting an estimated travel time to the destination from a start time of an event.

In some aspects, the techniques described herein relate to a method, further including: creating an event visible on an electronic calendar of the user indicating the battery pack will be charged between the charge initiation time and the expected departure time.

In some aspects, the techniques described herein relate to a method, wherein the event is visible on a calendar application on a smart phone of the user.

In some aspects, the techniques described herein relate to a method, wherein, when following the calendar-based charging strategy, an optimization charging strategy is overridden if following the optimization charging strategy would not allow the battery pack to reach the state of charge sufficient for the electrified vehicle to travel to the destination by the expected departure time.

In some aspects, the techniques described herein relate to a method, wherein, when following the calendar-based charging strategy, all other charging strategies are overridden.

In some aspects, the techniques described herein relate to a method, wherein the state of charge sufficient for the electrified vehicle to travel to the destination includes a state of charge sufficient for the electrified vehicle to travel to from the starting location to the destination, and back from the destination to the starting location.

In some aspects, the techniques described herein relate to a method, further including not charging to the battery pack if a current state of charge of the battery pack is sufficient for the electrified vehicle to travel from the starting location to the destination.

In some aspects, the techniques described herein relate to a method, wherein the state of charge sufficient for the electrified vehicle to travel from the starting location to the destination is based on a plurality of factors other than distance between the starting location and the destination.

In some aspects, the techniques described herein relate to a method, wherein the plurality of factors includes pre-conditioning of the electrified vehicle before the expected departure time.

In some aspects, the techniques described herein relate to a method, wherein the plurality of factors includes one or more of GPS information, an energy consumption per mile value of the electrified vehicle, a current state of charge of the battery pack, climate information, learned driving habits, and traffic information.

In some aspects, the techniques described herein relate to a method, wherein the destination is based on a location of an event in a calendar application of the user, and wherein the expected departure time is calculated by subtracting an estimated travel time to the location from a start time of the event.

In some aspects, the techniques described herein relate to a method, wherein the starting location is either an expected location of the electrified vehicle at the expected departure time, or a current location of the electrified vehicle.

In some aspects, the techniques described herein relate to a method, including: charging of a battery pack of an electrified vehicle according to a calendar-based charging strategy, wherein, when following the calendar-based charging strategy, other charging strategies are overridden.

In some aspects, the techniques described herein relate to a system for an electrified vehicle, including: a battery pack; and a control system configured to control charging of the battery pack according to a calendar-based charging strategy, wherein, when following the calendar-based charging strategy, the battery pack is charged to a state of charge sufficient for the electrified vehicle to travel from a current location of the electrified vehicle to a destination by an expected departure time, wherein the destination and the expected departure time are based on calendar information of a user of the electrified vehicle, wherein, when following the calendar-based charging strategy, other charging strategies are overridden.

In some aspects, the techniques described herein relate to a system, wherein the control system is configured to: calculate an amount of charge time required for the battery pack to reach the state of charge sufficient for the electrified vehicle to travel to the destination, and issue one or more commands to cause the battery pack to begin to charge at a charge initiation time determined by subtracting the calculated amount of charge time from the expected departure time.

In some aspects, the techniques described herein relate to a system, wherein the control system is configured to: create an event visible on an electronic calendar of the user indicating the battery pack will be charged between the charge initiation time and the expected departure time.

### BRIEF DESCRIPTION OF THE DRAWINGS

FIG. 1 schematically illustrates a powertrain of an electrified vehicle.

FIG. 2 schematically illustrates a vehicle system of an electrified vehicle.

FIG. 3 schematically illustrates a control system of the vehicle system of FIG. 2.

FIG. 4 is a flow chart representative of an example method of this disclosure.

FIG. 5 is an exemplary view of a calendar application, as viewed via a personal electronic device of a user or a human-machine interface of the electrified vehicle.

### DETAILED DESCRIPTION

This disclosure relates generally to calendar-based charging strategies for electrified vehicles. In an example strategy, a battery pack of an electrified vehicle is charged according to a calendar-based charging strategy during which other charging strategies, such as price-optimization charging strategies, are overridden. In this way, the battery pack will be charged so as to meet the specific driving needs of the user. These and other features are discussed in greater detail in the following paragraphs of this detailed description.

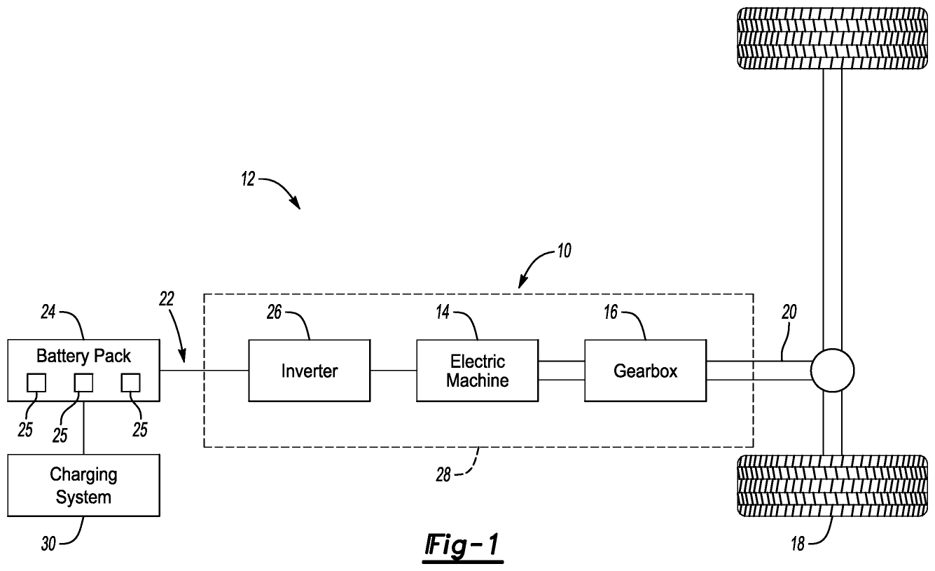

FIG. 1 schematically illustrates a powertrain 10 of an electrified vehicle 12. The electrified vehicle 12 may be a battery electric vehicle (BEV) or a plug-in hybrid electric vehicle (PHEV), for example. Therefore, although not shown in this embodiment, the electrified vehicle 12 could be equipped with an internal combustion engine that can be employed either alone or in combination with other energy sources to propel the electrified vehicle 12.

In the illustrated embodiment, the electrified vehicle 12 is a full electric vehicle propelled solely through electric power, such as by an electric machine 14, without any assistance from an internal combustion engine. The electric machine 14 may operate as an electric motor, an electric generator, or both. The electric machine 14 receives electrical power and provides a rotational output power. The electric machine 14 may be connected to a gearbox 16 for adjusting the output torque and speed of the electric machine 14 by a predetermined gear ratio. The gearbox 16 is connected to a set of drive wheels 18 by an output shaft 20. A voltage bus 22 electrically connects the electric machine 14 to a battery pack 24 through an inverter 26. The electric machine 14, the gearbox 16, and the inverter 26 may be collectively referred to as a transmission 28.

The battery pack 24 is an exemplary electrified vehicle battery. The battery pack 24 may be a high voltage traction battery pack that includes a plurality of battery assemblies 25 (i.e., battery arrays or groupings of battery cells) capable of outputting electrical power to operate the electric machine 14 and/or other electrical loads of the electrified vehicle 12 for providing the power necessary to propel the wheels 18. Other types of energy storage devices and/or output devices can also be used to electrically power the electrified vehicle 12.

The electrified vehicle 12 is also be equipped with a charging system 30 for charging the energy storage devices (e.g., battery cells) of the battery pack 24. The charging system 30 can be connected to an external power source for receiving and distributing power received from the external power source to the battery pack 24.

The powertrain 10 of FIG. 1 is highly schematic and is not intended to limit this disclosure. Various additional components could alternatively or additionally be employed by the powertrain 10 within the scope of this disclosure. In addition, the teachings of this disclosure may be incorporated into any type of electrified vehicle, including but not limited to cars, trucks, sport utility vehicles, etc.

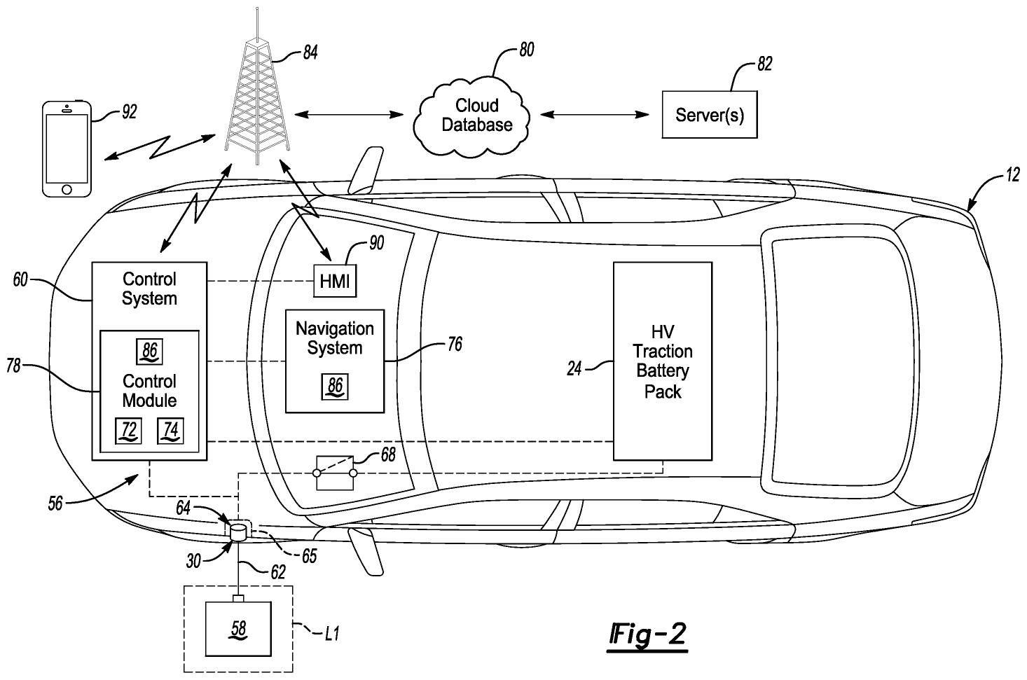

FIG. 2 is a highly schematic depiction of a vehicle system 56 that may be employed within an electrified vehicle, such as electrified vehicle 12 of FIG. 1. The various components of the vehicle system 56 are shown schematically to better illustrate the features of this disclosure. These components, however, are not necessarily depicted in the exact locations at which they would be found in an actual vehicle.

The vehicle system 56 is adapted to control charging of the energy storage devices (e.g., battery cells) of the battery pack 24. For example, in an embodiment, the vehicle system 56 may control battery pack 24 charging based on calendar information of a user, among other factors, as will be discussed below.

In an embodiment, the exemplary vehicle system 56 includes the battery pack 24, a charging system 30, a control system 60, and a navigation system 76. The battery pack 24 may include one or more battery arrays each having a plurality of battery cells or other energy storage devices. The energy storage devices of the battery pack 24 store electrical energy that is selectively supplied to power various electrical loads residing onboard the electrified vehicle 12. These electrical loads may include various high voltage loads (e.g., electric machines, etc.) or various low voltage loads (e.g., lighting systems, low voltage batteries, logic circuitry, etc.). The energy storage devices of the battery pack 24 are depleted of energy over time and therefore must be periodically recharged. Recharging can be achieved using the charging system 30 based on a charging control strategy executed by the control system 60, the details of which are further discussed below.

The charging system 30 may include a power cord 62 that connects between a charging port 64 of a vehicle inlet assembly 65 (located onboard the electrified vehicle 12) and an external power source 58. In an embodiment, the external power source 58 includes utility grid power. In another embodiment, the external power source 58 includes an alternative energy source, such as solar power, wind power, etc. In yet another embodiment, the external power source 34 includes a combination of utility grid power and alternative energy sources. The external power source 58 is located at a charging location L1. Exemplary charging locations include but are not limited to a public charging station located along the drive route, a driver's home, or a parking garage, for example.

Power from the external power source 58 may be selectively transferred over the power cord 62 to the electrified vehicle 12 for charging the energy storage devices of the battery pack 24. The charging system 30 may be equipped with power electronics configured to convert AC power received from the external power source to DC power for charging the energy source devices of the battery pack 24. The charging system 30 may also be configured to accommodate one or more conventional voltage sources from the external power source 58. In other embodiments, the charging system 30 could be a wireless charging system or a DC fast charging system.

In yet another embodiment, the charging system 30 includes a switch 68 for controlling the transfer of power to the battery pack 24. The switch 68 can be selectively actuated (i.e., opened) to stop or prevent charging the battery pack 24, such as when the battery pack 24 reaches a target state of charge (SOC) level at the charging location L1. In an embodiment, the switch 68 is movable between a closed position (shown in solid lines) in which power is permitted to flow to the battery pack 24 and an open position (shown in phantom lines) in which power is prohibited from flowing to the battery pack 24.

The control system 60 of the vehicle system 56 may control charging of the battery pack 24 by controlling operation of the charging system 30. To achieve this, the control system 60 may control when charging begins and ends, the length of charging, the power levels of the charging, etc.

The control system 60 may be part of an overall vehicle control system or could be a separate control system that communicates with the vehicle control system. The control system 60 may include one or more control modules 78 equipped with executable instructions for interfacing with and commanding operation of various components of the vehicle system 56. For example, in an embodiment, each of the battery pack 24, the charging system 30, and the navigation system 76 include a control module, and these control modules can communicate with one another over a controller area network to control charging of the battery pack 24. In another non-limiting embodiment, each control module 78 of the control system 60 includes a processing unit 72 and non-transitory memory 74 for executing the various control strategies and modes of the vehicle system 56.

The navigation system 76 may include a global positioning system (GPS) configured for communicating drive route information to the control system 60. The navigation system 76 may include or be in communication with a human-machine interface (HMI) 90, which may include a touchscreen, and may be located inside the electrified vehicle 12 for displaying the drive route and other related information. A user may interact with the HMI 90 via a touch screen, buttons, audible speech, speech synthesis, etc. In an embodiment, the drive route can be manually entered into the navigation system 76 using the HMI 90. In another embodiment, the drive route can be inferred based on historical data accumulated from prior drive routes the user has planned/traveled. Such historical route information may be saved within the navigation system 76 or within the non-transitory memory 74 of the control module 78 of the control system 60, for example. In still embodiment, the drive route can be inferred based on calendar information of a user.

The navigation system 76 may communicate additional information to the control system 60. This additional information could include the location of various charging locations along the drive route, charging prices associated with each charging location, etc.

In an embodiment, the control system 60 (and, optionally, the navigation system 76) may communicate over a cloud database 80 (i.e., the internet) to obtain various information stored on one or more servers 82. Each server 82 can identify, collect, and store user data associated with the electrified vehicle 12 for validation purposes. Upon an authorized request, data may be subsequently transmitted to the navigation system 76, or directly to the control system 60, via a cellular tower 84 or some other known communication technique (e.g., Wi-Fi, Bluetooth, etc.). The control system 60 and the navigation system 76 may each include a transceiver 86 for achieving bidirectional communication with the cellular tower 84. For example, the transceiver 86 can receive data from the server 82 or can communicate data back to the server 82 via the cellular tower 84. Although not necessarily shown or described in this highly schematic embodiment, numerous other components may enable bidirectional communication between the electrified vehicle 12 and the web-based servers 82.

The data received by the control system 60 from the navigation system 76 and/or the server 82 may be used in combination with other data to create a charging schedule for charging the battery pack 24. As discussed in greater detail below, the control system 60 may gather, analyze and/or calculate various data when planning the charging schedule.

A user or owner of the electrified vehicle 12 may interface with the web-based servers 82 using the HMI 90. For example, the HMI 90 may be equipped with an application (e.g., FordPass™ or another similar web-based application) for interfacing with the web-based servers 82. The HMI 90 may be located within a passenger cabin of the electrified vehicle 12 and may include various user interfaces for displaying information to the vehicle occupants and for allowing the vehicle occupants to enter information into the HMI 90. The vehicle occupants may interact with the user interfaces presentable on the HMI 90 via touch screens, tactile buttons, audible speech, speech synthesis, etc.

A user or owner of the electrified vehicle 12 may alternatively or additionally interface with the web-based servers 82 a personal electronic device 92 (e.g., a smart phone, tablet, computer, wearable smart device, etc.). The personal electronic device 92 may include an application (e.g., FordPass™ or another similar application) that includes programming to allow the user to employ one or more user interfaces. The application may be stored in a memory of the personal electronic device 92 and may be executed by a processor of the personal electronic device 92. The personal electronic device 92 may additionally include a transceiver that is configured to communicate with the web-based servers 82 over the cellular tower(s) 84 or some other wireless link.

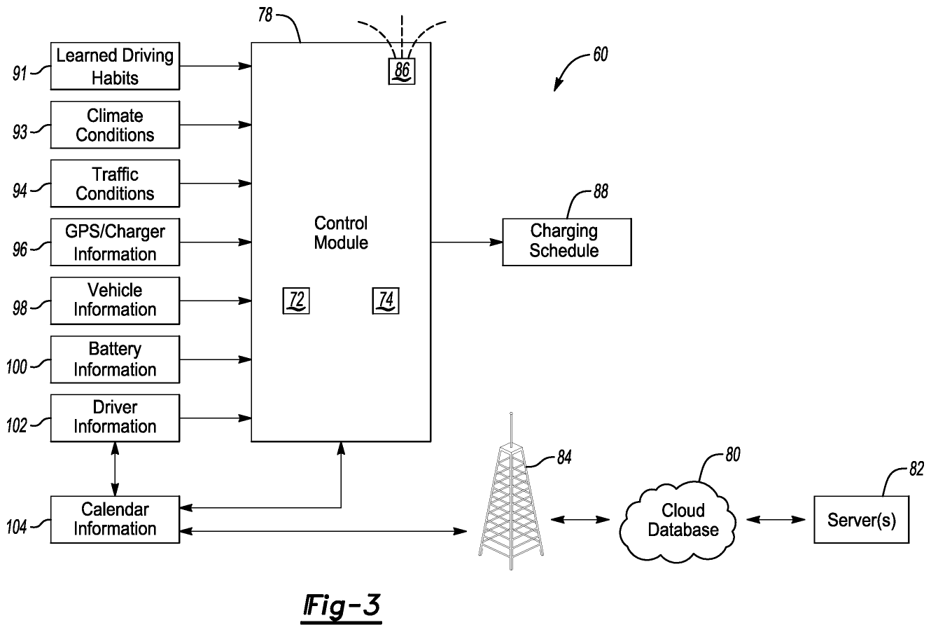

Referring now primarily to FIG. 3, the control module 78 of the control system 60 may receive and process various inputs for creating a charging schedule 88 for charging the battery pack 24. A first input to the control module 78 may include learned driving habits 91 of a driver of the electrified vehicle 12. The learned driving habits 91 may be inferred or learned values that are based on historical usage data associated with the electrified vehicle 12. For example, the control module 78 may learn the times a day the electrified vehicle 12 is operated by control logic and/or algorithms included within the control module 78. The learned times of day may correspond to a time of day on a specific day of the week based on the frequency or historical use of the electrified vehicle 12 relative to that time of day. In an embodiment, the learned times of day may further correspond to a time of day on a specific day of the week that the power cord 62 is removed from the vehicle inlet assembly 65 or any other action that is indicative of an expected upcoming vehicle drive cycle. The learned times may be recorded within the memory 74 of the control module 78 each time that signals are received by the control module 78 indicating that the power cord 62 is removed from the vehicle inlet assembly 65, or any other action that is indicative of an expected upcoming vehicle drive cycle. In an embodiment, a learning tool such as a probabilistic model or neural network is used to infer or predict the learned driving habits 91. In another embodiment, a cloud based computing tool can be used to provide the learned driving habits. However, the specific methodology used to predict the learned driving habits 91 is not intended to limit this disclosure.

A second input to the control module 78 may include climate conditions 93. The climate conditions 93 may be received from one of the servers 82 over the cloud database 80. In an embodiment, the climate conditions 93 include a prediction of the state of the ambient surroundings (e.g., temperature, sun, rain, wind, etc.) for a given location on a given date and time associated with the expected upcoming drive cycle.

A third input to the control module 78 may include traffic conditions 94. The traffic conditions 94 may be received from another one of the servers 82 over the cloud database 80. In an embodiment, the traffic conditions 94 include a prediction of the traffic situation (e.g., light, heavy, etc.) for a given location on a given date and time associated with the expected upcoming drive cycle.

A fourth input to the control module 78 may include GPS information 96 from the navigation system 76. The GPS information 96 may include but is not limited to location information (e.g., home, work place, etc.), date and time information (e.g., AM, PM, night, day, etc.), and charging location information (e.g., charging type, availability, prices, etc.).

A fifth input to the control module 78 may include vehicle information 98. The vehicle information 98 may be communicated from a vehicle control module that is separate from the control module 78 and may include information such as energy consumption per mile (i.e., kWh/mile), etc.

A sixth input to the control module 78 may include battery information 100. The battery information 100 may be communicated from a battery electric control module associated with the battery pack 24 and may include information such as current battery state of charge, battery temperature, battery age, etc.

A seventh input to the control module 78 may include driver information 102. The driver information 102 may be received from a personal electronic device, such as a cell phone, of the driver of the electrified vehicle and may include calendar information and other driver specific information.

Another input includes calendar information 104 of a user of the electrified vehicle 12. The user of the electrified vehicle 12 may be a primary driver of the electrified vehicle 12, an owner of the electrified vehicle 12, a secondary driver of the electrified vehicle 12, or anyone else designated by the owner of the electrified vehicle 12. When the calendar information 104 is calendar information of the driver of the electrified vehicle 12, the calendar information 104 may be considered a type of driver information 102.

The calendar information 104 includes information from a calendar of a user of the electrified vehicle 12 and which the user has decided to share for use in charging the electrified vehicle 12. In a particular example, the user has consented to share information from a personal calendar of the user with the web-based servers 82. In one embodiment, the user has consented to such sharing via an application, such as the FordPass™ application, via an interface of the HMI 90 or the personal electronic device 92.

When consenting to sharing their calendar information, the user can choose which calendar the user wishes to share with the web-based servers 82. For instance, the user can share all information from a particular calendar application, such as Calendar (made by Apple, Inc.), Google Calendar (made by Google), Microsoft Outlook (made by Microsoft), etc. Alternatively or additionally, the user can share one or more individual calendars within a particular calendar application, such as a “family” calendar, “work” calendar, etc. Following consent, the web-based servers 82 sync with the shared calendar and have access to the shared calendar information. The shared calendar information can then be accessed and used by the control system 60.

In an aspect of this disclosure, the shared calendar information includes all information stored in the shared calendar, including all information corresponding to the events stored in the shared calendar. Each event includes additional information such as a title of the event, a location of the event, a start time of the event, and an end time of the event, as examples.

Relying on the various inputs, the control module 78 may be programmed to execute one or more algorithms for creating the charging schedule 88. The charging schedule 88 can be used to control charging of the battery pack 24.

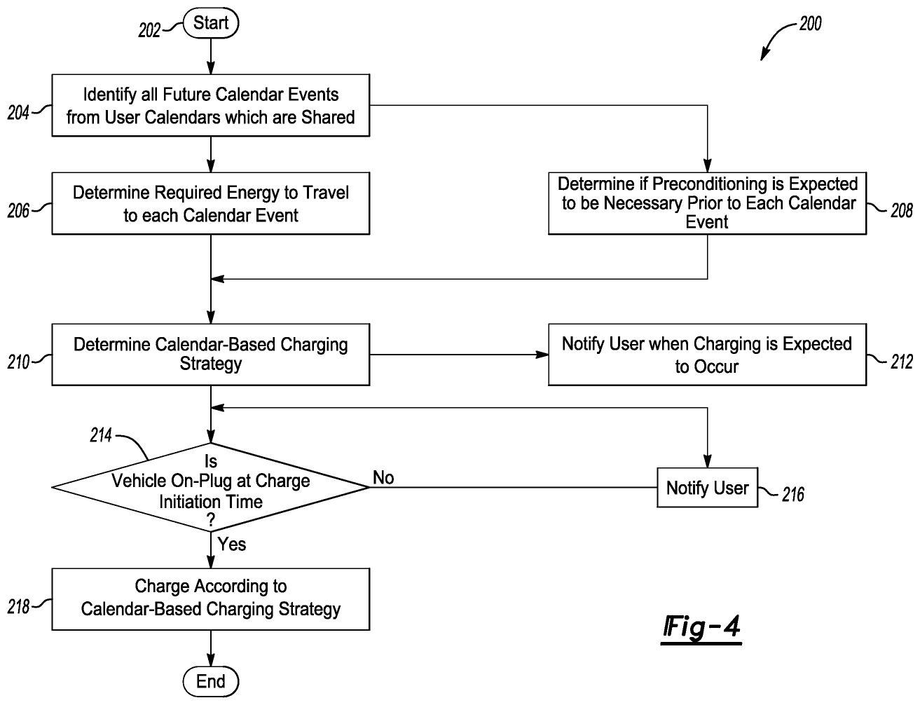

FIG. 4, with continued reference to FIGS. 1-3, illustrates an exemplary method 200 for controlling charging of the battery pack 24 of the electrified vehicle 12. In an embodiment, the control system 60, and in particular the control module 78, is programmed with one or more algorithms adapted to execute the exemplary method 200.

The method 200 begins at 202. In order for the method 200 to begin, a user must consent to sharing at least some calendar information with the web-based servers 82. Further, the user must designate at least one electrified vehicle that the user wishes to be charged according to a calendar-based charging strategy.

If the user owns multiple electrified vehicles, the user can select one of their electrified vehicles to be charged using a calendar-based charging strategy using calendar information from a particular calendar. The user that owns multiple vehicles, for example, may set another of the user's vehicles to be charged according to a calendar-based charging strategy using calendar information from another calendar. For instance, a user may set a first electrified vehicle to be charged using a first calendar associated with a first user, and a may also set a second electrified vehicle to be charged using a second calendar associated with a second user. In this way, multiple electrified vehicles are charged according to the specific needs of the user that is expected to be driving that particular electrified vehicle. The remainder of the method 200 will be described relative to one electrified vehicle.

At block 204, calendar information 104 is received from the user, and the calendar events are identified. The calendar information 104 includes future events, including titles, locations, start times, and end times of those events.

At block 206, the energy required to travel to the future events is determined. In particular, the state of charge (SOC) of the battery pack 24 sufficient to permit the electrified vehicle 12 to travel from an expected starting location to the destination is determined. In a further embodiment, the state of charge (SOC) of the battery pack 24 sufficient to permit the electrified vehicle 12 to travel from an expected starting location to the destination, and to return from the destination back to the expected starting location, is determined. In one example, the expected starting location is a home of the user, and the destination is a workplace of the user. In that example, at 206, an SOC sufficient to permit the electrified vehicle 12 to complete a drive cycle including traveling from home to work, and back home from work, is determined. One-way trips, round trips, and multi-leg trips are referred to as drive cycles in this disclosure.

The term “sufficient,” as used relative to an SOC of the battery pack 24 being sufficient to permit the electrified vehicle 12 to travel from an expected starting location to the destination, is used to incorporate an estimate of various factors in addition to the distance the electrified vehicle 12 is expected to travel during a particular drive cycle, such as between the starting location and destination. Those other factors include learned driving habits 91, climate conditions 93, traffic conditions 94, etc. Yet another factor may also include any energy that the electrified vehicle 12 is scheduled to transfer from the battery pack 24 to a home of the user or to an electrical grid. These factors, and others, may be considered when calculating an SOC that is sufficient to permit the electrified vehicle 12 to complete a particular drive cycle.

Another factor includes, at block 208, whether pre-conditioning of the electrified vehicle 12 is expected to be needed in advance of, or during, a particular drive cycle. For example, using climate conditions 93, and in particular expected climate conditions at or around an upcoming event, the control system 60 calculates whether the passenger cabin of the electrified vehicle 12 should be heated or cooled in order to meet certain customer comfort expectations. If pre-conditioning should be provided for a particular event, then the energy required to pre-condition the electrified vehicle 12 should be factored into the whether the SOC of the battery pack 24 is sufficient for that drive cycle.

Based on the calendar information and the considerations at blocks 204, 206, and 208, a calendar-based charging strategy is defined at block 210. Further, if the user consents to receiving such information, the user is informed as to when charging is expected to occur, at block 212. The user may be informed by having a notification pushed to the user's personal mobile device 92, such as through SMS text message and/or through an application, like FordPass™. The expected charging times may also be pushed to a calendar of the user, such that the user can view the expected charging times using a calendar application on the personal mobile device 92 and/or via the HMI 90.

With the calendar-based charging strategy defined, the method 200 next considers whether the electrified vehicle 12 is on-plug at or in advance of a charge initiation time, at block 214. If the electrified vehicle 12 is not on-plug, a notification is sent to the user, at block 216, to inform the user that the calendar-based charging strategy cannot be followed unless the user intervenes by plugging in the electrified vehicle 12. Otherwise, the method continues to block 218, where the electrified vehicle 12 is charged according the calendar-based charging strategy.

The electrified vehicle 12 may be charged according to other strategies, including price-optimization strategies, such as when the SOC of the battery pack 24 is relatively low and there are no upcoming events on a calendar of the user. The electrified vehicle 12 may also follow other charging strategies in parallel with the calendar-based charging strategy, if the other strategies do not inhibit the ability of the battery pack 24 to reach the SOC sufficient to complete the upcoming drive cycle. Otherwise, the control system 60 will override all other charging strategies when the battery pack 24 is being charged according to the calendar-based charging strategy. In this way, the control system 60 prioritizes providing the battery pack 24 with an SOC corresponding to the events in the calendar of the user, which are directly indicative of the upcoming driving needs of the user.

The calendar-based charging strategy defined in block 210 includes calculating when a charging operation should be initiated for a particular event. The calendar-based charging strategy defined in block 210 also includes calculating an expected departure time associated with that particular event.

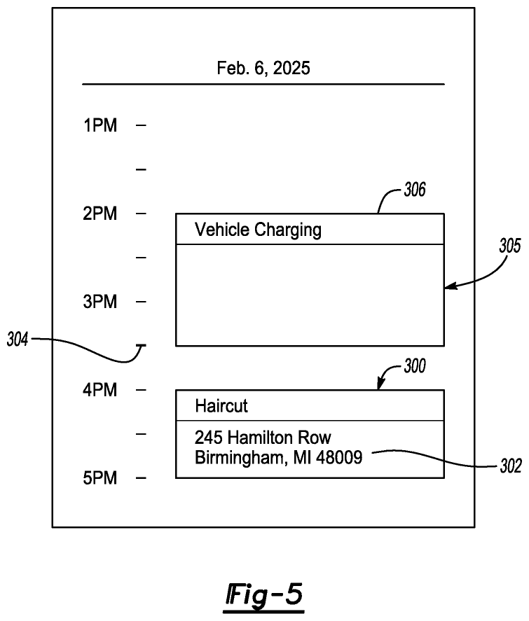

Regarding the expected departure time, when creating an event in their personal calendar, most individuals do not create events based on when they need to leave for the event. For instance, if a user has a haircut at 4:00 PM on Feb. 6, 2025, the individual will likely create an event 300 indicating the start time of the haircut, as represented in FIG. 5. The control system 60 can deduce an expected departure time using the calendar information. As shown in FIG. 5, the event 300 begins at 4:00 PM, is expected to end at 5:00 PM, and the calendar information includes an address 302 associated with the event 300. Using this information, coupled with the other factors 91, 93, 94, 96, 98, 100, 102, the control system 60 can determine an expected departure time of the electrified vehicle 12. In this example, the starting location of the electrified vehicle 12 is a home of the user. In other examples, the starting location may be a location other than the home of the user. The control system 60 determines that the electrified vehicle 12 is expected to depart from the starting point at the expected departure time 304, which here is 3:30 PM, because the control system 60 has estimated that it will take about 30 minutes for the user to travel from the starting location to the location indicated by address 302.

Alternatively, the control system 60 can determine departure time based on an alarm set on the user's personal mobile device 92. The control system 60 can deduce that the alarm corresponds to a departure time if the alarm is saved using a label such as “leave for haircut,” or the like, or the alarm is within a predefined amount of time, such as 15 minutes, from the departure time that the control system 60 deduced using the aforementioned technique or another technique. If a departure alarm is identified, then the control system 60 may determine the departure time to be the earliest of the departure alarm time or the expected departure time determined based on the estimated travel time to the appointment location. In another example, if no appointment location information is given, then the departure time will be based on the alarm time, if a departure alarm is identified.

The term starting point refers to a location where the drive cycle will begin. The starting point may be estimated using learned driving habits 91 of the user. The starting point may be updated over time, or in real time, using GPS information, for example.

In this example, the control system 60 determines that the current SOC of the battery pack 24 is not sufficient to complete the drive cycle corresponding with the event 300. The drive cycle could include a round trip, including the electrified vehicle 12 traveling from the starting point to the destination and returning from the destination to the starting point. Alternatively, the drive cycle could be a one-way trip, in which the electrified vehicle 12 travels from the starting point to the destination, or a multi-leg trip, in which one or more stops take place when traveling to or from a destination.

Regarding multi-leg trips, the control system 60 can estimate whether the user intends to complete a multi-leg trip by comparing the distances and times between multiple calendar events. If, for example, the user has multiple calendar events in series, and those events take place in close succession such that the user does not have time to return to a starting point, such as home, in between the events, then the control system 60 will determine that the user will be completing a multi-leg trip. In the example of FIG. 5, the control system 60 determines that the drive cycle corresponding to event 300 is a round trip, from the starting point, to the location indicated by address 302, and back to the starting point.

The control system 60 calculates how long it will take for the battery pack 24 to reach the SOC sufficient to complete the drive cycle corresponding to event 300. In this case, the control system 60 calculated that it will take 90 minutes of charging for the battery pack 24 to reach the SOC sufficient to complete the drive cycle corresponding to event 300. The time may be longer if pre-conditioning is expected to be required, as determined by block 208. The time may also be longer if the user, for example, desires to complete drive cycles with a minimum SOC, such as 30% SOC, remaining. The user may set such a minimum SOC in some examples. In those examples, the control system 60 calculates how long it will that for the battery pack 24 to reach the SOC sufficient to complete the drive cycle corresponding to event 300, while leaving the battery pack 24 with the minimum SOC immediately following completion of the drive cycle.

Regardless, at block 210, a charging event 305 is set to be initiated at a charge initiation time 306 and to end at the expected departure time 304. The charge initiation time 306 is calculated by subtracting how long it will take for the battery pack 24 to reach the SOC sufficient to complete the drive cycle from the expected departure time. In this example, the charge initiation time 306 is 2:00 PM. Per block 212, the user may view the charging event 305 in a calendar application on their personal electronic device 92 or via HMI 90, as examples. The user may receive one or more notifications corresponding to the charging event 305.

During the charging event 305, other control strategies used for charging the battery pack 24 are overridden, in one aspect of this disclosure. For instance, if an optimization charging strategy, such as a price-optimization strategy or a battery-health optimization strategy would otherwise not have charged the battery pack 24 between 2:00 PM and 3:30 PM, the control system 60 overrides those strategies and charges the battery pack 24. The control system 60 will only follow another charging strategy during a charging event set according to the calendar-based charging strategy if the calendar-based charging strategy can still meet its objective of providing an SOC sufficient to complete the drive cycle by the expected departure time.

In another aspect of this disclosure, if the SOC of the battery pack 24 were sufficient to complete the drive cycle corresponding with the event 300, no charge would be added to the battery pack 24 in advance of the event 300 based on the calendar-based control strategy.

While only one calendar event 300 is shown in FIG. 5, the control system 60 can process all calendar information shared by the user with the web-based servers 82. In one example, at block 210, the calendar-based charging strategy plans charging events to build charging schedule 88 up to a predefined amount into the future, such as one week into the future, one month into the future, etc.

It should be understood that terms such as “about,” “substantially,” and “generally” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A method, comprising:
charging of a battery pack of an electrified vehicle according to a calendar-based charging strategy, wherein, when following the calendar-based charging strategy, the battery pack is charged to a state of charge sufficient for the electrified vehicle to travel from a starting location of the electrified vehicle to a destination by an expected departure time, wherein the destination and the expected departure time are based on calendar information of a user of the electrified vehicle, wherein, when following the calendar-based charging strategy, other charging strategies are overridden.

2. The method as recited in claim 1, wherein a control system is programmed to control charging of the battery pack.

3. The method as recited in claim 2, wherein the control system is a component of the electrified vehicle and is powered by the battery pack, or the control system is a component of a server system.

4. The method as recited in claim 1, further comprising:
calculating an amount of charge time required for the battery pack to reach the state of charge sufficient for the electrified vehicle to travel to the destination, and
beginning to charge the battery pack according to the calendar-based charging strategy at a charge initiation time determined by subtracting the calculated amount of charge time from the expected departure time.

5. The method as recited in claim 4, wherein the expected departure time is determined by subtracting an estimated travel time to the destination from a start time of an event.

6. The method as recited in claim 4, further comprising:
creating an event visible on an electronic calendar of the user indicating the battery pack will be charged between the charge initiation time and the expected departure time.

7. The method as recited in claim 6, wherein the event is visible on a calendar application on a smart phone of the user.

8. The method as recited in claim 4, wherein, when following the calendar-based charging strategy, an optimization charging strategy is overridden if following the optimization charging strategy would not allow the battery pack to reach the state of charge sufficient for the electrified vehicle to travel to the destination by the expected departure time.

9. The method as recited in claim 1, wherein, when following the calendar-based charging strategy, all other charging strategies are overridden.

10. The method as recited in claim 1, wherein the state of charge sufficient for the electrified vehicle to travel to the destination includes a state of charge sufficient for the electrified vehicle to travel to from the starting location to the destination, and back from the destination to the starting location.

11. The method as recited in claim 1, further comprising not charging to the battery pack if a current state of charge of the battery pack is sufficient for the electrified vehicle to travel from the starting location to the destination.

12. The method as recited in claim 1, wherein the state of charge sufficient for the electrified vehicle to travel from the starting location to the destination is based on a plurality of factors other than distance between the starting location and the destination.

13. The method as recited in claim 12, wherein the plurality of factors includes pre-conditioning of the electrified vehicle before the expected departure time.

14. The method as recited in claim 12, wherein the plurality of factors includes one or more of GPS information, an energy consumption per mile value of the electrified vehicle, a current state of charge of the battery pack, climate information, learned driving habits, and traffic information.

15. The method as recited in claim 1, wherein the destination is based on a location of an event in a calendar application of the user, and wherein the expected departure time is calculated by subtracting an estimated travel time to the location from a start time of the event.

16. The method as recited in claim 1, wherein the starting location is either an expected location of the electrified vehicle at the expected departure time, or a current location of the electrified vehicle.

17. A method, comprising:
charging of a battery pack of an electrified vehicle according to a calendar-based charging strategy, wherein, when following the calendar-based charging strategy, other charging strategies are overridden.

18. A system for an electrified vehicle, comprising:
a battery pack; and
a control system configured to control charging of the battery pack according to a calendar-based charging strategy, wherein, when following the calendar-based charging strategy, the battery pack is charged to a state of charge sufficient for the electrified vehicle to travel from a current location of the electrified vehicle to a destination by an expected departure time, wherein the destination and the expected departure time are based on calendar information of a user of the electrified vehicle, wherein, when following the calendar-based charging strategy, other charging strategies are overridden.

19. The system as recited in claim 18, wherein the control system is configured to:
calculate an amount of charge time required for the battery pack to reach the state of charge sufficient for the electrified vehicle to travel to the destination, and
issue one or more commands to cause the battery pack to begin to charge at a charge initiation time determined by subtracting the calculated amount of charge time from the expected departure time.

20. The system as recited in claim 19, wherein the control system is configured to:
create an event visible on an electronic calendar of the user indicating the battery pack will be charged between the charge initiation time and the expected departure time.
